(19) United States
(12) Patent Application Publication
(10) Pub. No.: US 2004/0098469 A1
(43) Pub. Date: May 20, 2004

(54) Communication support method, communication server comprising it, and communication support system

(76) Inventors: Toshiki Kindo, Kanagawa (JP); Takehiko Shida, Kanagawa (JP); Natsuki Oka, Osaka (JP); Kentaro Onizuka, Kyoto (JP)

Correspondence Address: RATNERPRESTIA, P O BOX 980, VALLEY FORGE, PA, 19482-0980, US

(21) Appl. No.: 10/472,989

(22) PCT Filed: Oct. 15, 2002
(86) PCT No.: PCT/JP02/10644

(30) Foreign Application Priority Data
Oct. 15, 2001 (JP) 2001-316548
Oct. 10, 2002 (JP) 1002-288602

(51) Int. Cl. G06F 15/16

(52) U.S. Cl. 709/219; 709/206

(57) ABSTRACT

A communication support system comprises an information terminal device (101) for inputting and outputting voices (or sentences) and a personal mixing section (111) for outputting voices (or sentences) input to a communication server (102) by synthesizing them according to the interest of an individual user. Thus, one of conversations flowing through the communication server that matches with a user's interest is directed to the user.

### TECHNICAL FIELD

The present invention relates to a communication support system used by a plurality of users through an information communication network that uses electrons, radio or light as a medium. More particularly, it relates to a communication support method that selects or recommends an appropriate counterpart in a conversation responsive to an interest of individual users, and a communication support system using the same method.

### BACKGROUND ART

A communication support system has been known, e.g., as disclosed in Japanese Patent Unexamined Publication No. 2000-132509. FIG. 12 shows the conventional communication support system disclosed in this publication.

In FIG. 12, server 1200 comprises communication controller 1211, input-output section 1212, relation-depth calculator 1213, placement calculator 1214, on-screen display section 1215, personal information management database 1216, personal characteristics information database 1217, rapport depth database 1218, and code-word database 1219. Communication controller 1211 communicates with client terminal 1230 via network 1220. Input-output section 1212 shows a user via browser 1231 a keyword of personal information registered in code-word database 1219, and a selection value of the keyword or a prioritized keyword if registered in personal characteristics information database 1217. In the case of no registration of a selection value or a keyword prioritized in the database, or if the user wants to change them, the selection value related to the keyword input by the user or the priority order of this keyword is obtained as the characteristics of this user, and registered in personal characteristics information database 1217.

Relation-depth calculator 1213 calculates a relation depth between users' characteristics based on characteristics values about a plurality of users stored in personal characteristics information database 1217, and transfers the result to placement calculator 1214. In response to the relation depth between users' characteristics stored in rapport depth database 1218, placement calculator 1214 calculates a placement such that icons corresponding to closely related users are placed closely to each other on the screen, and transfers the result to the on-screen display section. On-screen display section 1215 displays the icons on the screen with browser 1231 based on the placement calculated by screen calculator 1214 for identifying the plurality of users.

A way of producing personal characteristics information is disclosed in Japanese Patent Unexamined Publication No. H09-288683, i.e., a personal file including personal interests is produced.

When a user want to find a counterpart from those whom the user is interested in and narrows down them to a particular one, the foregoing conventional structure, however, needs the following troublesome procedure: All the keywords registered and having high-degree of interest are reset to have low-degree of interest through input-output section 120, and then only the keywords targeted in this case are assigned high-degree of interest. Therefore, the conventional structure needs to change a targeted interest every instant in order to communicate with a counterpart, and it is difficult for the conventional method and system.

### DISCLOSURE OF THE INVENTION

The present invention aims to provide a communication support method and a communication support system, which can change an interesting target with ease and select an appropriate counterpart in response to the change of interest on real time base.

The communication support method of the present invention supports a plurality of users to communicates with each other appropriately in response to their own interests through an information network, and analyzes the information (a personal profile including the user's interest and a message on a topic the user want to discuss) transmitted from each one of the users, thereby finding a depth of similarity between the users and synthesizing the information (or message) transmitted according to the depth of similarity before transmitting the synthesized information. This method allows forming a group dynamically in response to individual user's interest. As a result, a user only hears the voices of the other users sharing a common topic, and the group seems to be dynamically formed.

The communication support method of the present invention supports a plurality of users to communicate with each through an information network, the method includes the following steps:

receiving personal profiles including users' interests, and messages on topics the users want to discuss now;

analyzing the messages;

producing a depth of interest of each one of the users respectively based on the analysis and the personal profiles;

calculating a depth of interest similarity between each one of the users based on the depth of interest;

synthesizing messages of each one of the users based on the depth of similarity; and

transmitting the synthesized messages to the users.

This method allows transmitting only a topic, which a user wants to discuss, to the user, so that the user can find an counterpart appropriate to the topic.

The personal profile used in the foregoing method includes at least one of the information about the user, the information about the user's interest, or an environment of user's terminal. This preparation allows receiving extensive messages that match the user's taste or environment.

The communication support method of the present invention further includes a step of converting a message using a similarity as a weight. This method allows informing a user of a depth of matching of a received message with the user's interest.

The communication support method of the present invention further includes the steps of:

analyzing the message for extracting a keyword indicating a present interest, thereby producing a content profile; and

transmitting the content profile together with the message.

This method allows passing an interest included in the message with a common language between personal mixing sections.

The communication support method of the present invention supports a plurality of users to communicate with each other through an information communication network, and the method comprising the steps of:

receiving a personal profile including user's interest, and a message on a topic the user wants to discuss now;

analyzing the message, extracting a keyword indicating the present interest, and producing a content profile;

preparing the message, the personal profile and the content profile into one set, and storing the set in a memory;

producing a depth of present interest based on the personal profile received and the content profile corresponding to this personal profile;

calculating a depth of similarity by comparing this depth of the present interest with another depth of present interest based on the personal profile and the content profile read-out from the memory;

converting the messages using the depth of similarity as a weight; and

transmitting the converted messages.

This method allows a user to receive messages, e.g., out of other users' speeches in the past, the messages agreeing with the present interest.

The messages used in the communication support method of the present invention are formed of at least one of voice or text, so that a user can recognize the message with voice or text.

The message of the communication support method of the present invention is converted by converting at least one of voice volume, voice quality, a size of letter, a color of letter, or a typeface, following the weight. This conversion informs a user through intuition of a matching depth between the message and the user's interest.

The communication server of the present invention is accessed by a plurality of users through the information communication network, and includes the following elements:

analyzing means for analyzing information (or a personal profile including his or her interest, and a message on a topic he or she wants to discuss now) transmitted by individual users;

means for finding a depth of similarity in response to an interest of individual users; and

transmitting means for synthesizing information (or message) in response to the depth of similarity and transmitting the information (or the message).

This structure allows forming a group dynamically in response to an interest of individual users. As a result, a user can only hear the voices of other users who share a common topic, so that it seems that a group is formed dynamically.

The communication server of the present invention is accessed by a plurality of users through the information communication network, and includes the following elements:

receiving means for receiving a personal profile including his or her interest, and a message of topics he or she wants to discuss now, transmitted by individual users;

analyzing means for analyzing the message;

producing means for producing a depth of present interest based on the analysis and the personal profile;

synthesizing means for synthesizing a message based on the depth of the interest; and

transmitting means for transmitting the synthesized message.

This structure allows outputting a conversation matching a user's interest out of conversations flowing in the communication server to the user, so that anyone can find a counterpart who shares an interest for enjoying a conversation just by accessing a specified access point at anytime.

The communication server of the present invention further includes converting means for converting a message with a depth of similarity as a weight. This structure informs a user of a matching degree between a message received and the user's interest.

The analyzing means of the communication server of the present invention produces a content-profile which includes a keyword, indicating a present interest, extracted from the message, and the transmitting means transmits the content-profile corresponding to the message. This structure allows the personal mixing sections to pass an interest in the message in a common language between the mixing sections.

The communication server of the present invention is used by a plurality of users through the information communication network, and includes the following elements:

receiving means for receiving a personal profile including the user's interest, and a message on a topic the user wants to discuss now, transmitted by individual users;

producing means for producing a content-profile by extracting a keyword, which indicates a present interest, from the message;

memory means for storing a set of the message, the personal profile and the content profile in a memory;

producing means for producing a depth of a present interest based on the personal profile received and its corresponding content profile;

calculating means for calculating a depth of similarity by comparing this depth of the present interest with another depth of present interest based on the personal profile and the content profile read-out from the memory;

converting means for converting the messages using the depth of similarity as a weight; and

transmitting means for transmitting the converted messages.

This structure allows a user to receive a message, e.g., out of other users' speeches in the past, the message agreeing with the present interest.

The message used in the communication server of the present invention is formed of at least one of voice or text, so that a user can recognize the message with voice or text.

The conversion means of the communication server of the present invention varies at least one of a voice volume, voice quality, a size of letter, a color of letter or a typeface, following the weight. Thus a user can know a matching degree of the message to an interest through intuition.

The communication support system of the present invention is used by a plurality of users through an information communication network, and comprises the following elements:

a communication server of the present invention; and

an information terminal device that includes the following sub-elements:

producing means for producing a personal profile including a user's interest;

changing means for changing the personal profile;

inputting means for inputting a message on a topic the user wants to discuss now;

transmitting means for transmitting the personal profile and the message to the communication server; and

receiving means for receiving the message supplied from the server.

According to this structure, speaking a topic that the user is interested in through the information terminal device, the user can receive a speech selected, because of matching the user's present interest, from the speeches spoken by the users joining the communication support system.

When any user accesses a given access point anytime and speaks about a topic the user at present interested in through the information terminal device, the user can receive a speech selected, because of matching the user's present interest, from the speeches spoken by users joining the communication support system. As a result, the user can find a counterpart sharing the same interest with the user, and enjoy a conversation.

The information terminal device of the communication support system of the present invention further receives a content-profile, and includes changing means for changing the personal profile with this content profile. According to this structure, if a user finds an interesting content in the message received, the user can add the content as the user's interest with ease to the personal profile, and when the user speaks about this interest from now on, the user can receive messages matching the interest.

As discussed above, according to the present invention, a user can easily change a subject that the user is interested in, and the communication support system can select and recommend a counterpart to the user in response to the change on a real time basis.

### BRIEF DESCRIPTION OF THE DRAWINGS

FIG. 1 is a block diagram illustrating a communication support system in accordance with a first exemplary embodiment of the present invention.

FIG. 2 is a block diagram illustrating a functional structure of an information terminal device in accordance with the first exemplary embodiment of the present invention.

FIG. 3 is a wiring diagram of a communication server in accordance with the first exemplary embodiment of the present invention.

FIG. 4A shows a data structure of a personal profile in accordance with the first exemplary embodiment of the present invention.

FIG. 4B shows a data structure of a content profile in accordance with the first exemplary embodiment of the present invention.

FIG. 5 is a flowchart illustrating an operation of the communication support system in accordance with the first exemplary embodiment of the present invention.

FIG. 6A shows a depth of interest indicated by a personal profile of user I in accordance with the first exemplary embodiment of the present invention.

FIG. 6B shows a depth of interest indicated by a personal profile of user J in accordance with the first exemplary embodiment of the present invention.

FIG. 7 is a block diagram illustrating a communication support system in accordance with a second exemplary embodiment of the present invention.

FIG. 8 is a wiring diagram of a communication server in accordance with the second exemplary embodiment of the present invention.

FIG. 9 is a flowchart illustrating an operation of the communication support system in accordance with the second exemplary embodiment of the present invention.

FIG. 10 shows a thread structure in accordance with the second exemplary embodiment of the present invention.

FIG. 11A shows an interface displayed on a screen of an information terminal device in accordance with the second exemplary embodiment of the present invention.

FIG. 11B shows another interface displayed on a screen of an information terminal device in accordance with the second exemplary embodiment of the present invention.

FIG. 12 is a block diagram of a conventional communication support system.

### PREFERRED EMBODIMENTS OF THE INVENTION

Exemplary embodiments of the communication support system of the present invention are demonstrated hereinafter with reference to the accompanying drawings.

### Exemplary Embodiment 1

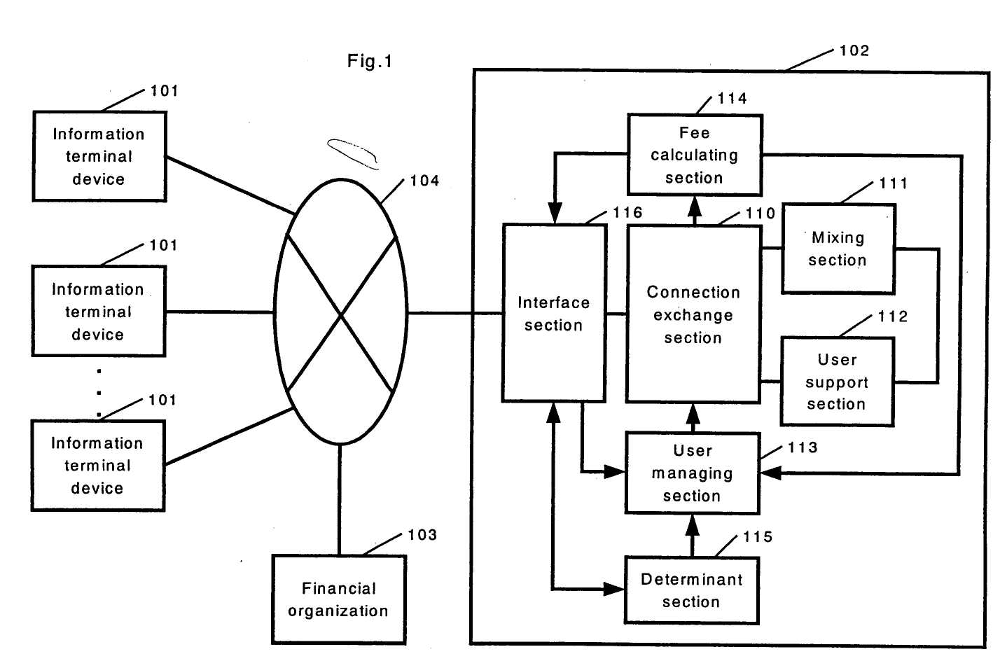

FIG. 1 is a block diagram illustrating a communication support system in accordance with the first exemplary embodiment. The communication support system comprises a plurality of information terminal devices 101, communication server 102, and financial organization 103. Those elements are coupled to information communication network 104.

Information terminal device 101 is, e.g., a personal computer or a cellular phone used by a user, and is installed with a browse such as the Internet Browse, so that device 101 can access communication server 102 through information communication network 104.

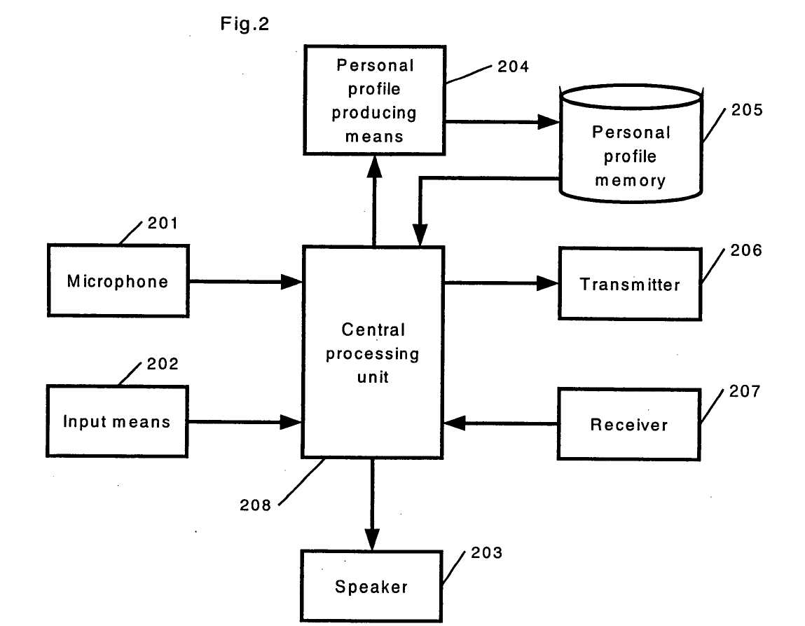

FIG. 2 is a block diagram illustrating a functional structure of information terminal device 101, which comprises the following elements:

microphone 201 through which a user inputs voices;

input means 202 through which a user inputs his or her taste upon necessary;

speaker 203, i.e., output means, for outputting a signal supplied from communication server 102;

personal-profile producing means 204 for detecting an interest from information input by a user through input means 202, and producing a personal profile;

personal-profile memory 205 for storing a personal profile;

transmitter 206 for transmitting the personal profile and the voices supplied from microphone 201 to communication server 102;

receiver 207 for receiving voice data and information data supplied from server 102; and

central processing unit (CPU) 208 for controlling overall information terminal device 101.

In the preferred embodiments, personal-profile producing means 204 can update a personal-profile with a content-profile, detailed later, obtained from an output from personal mixing section 302, i.e., the output is a conversation obtained from personal mixing section 302.

The personal profile refers to depths about interests and tastes prepared by a user with regard to personal information and a plurality of keywords given to the information received from server 102. The personal information includes a user ID, full name, age, telephone number, address, and e-mail address.

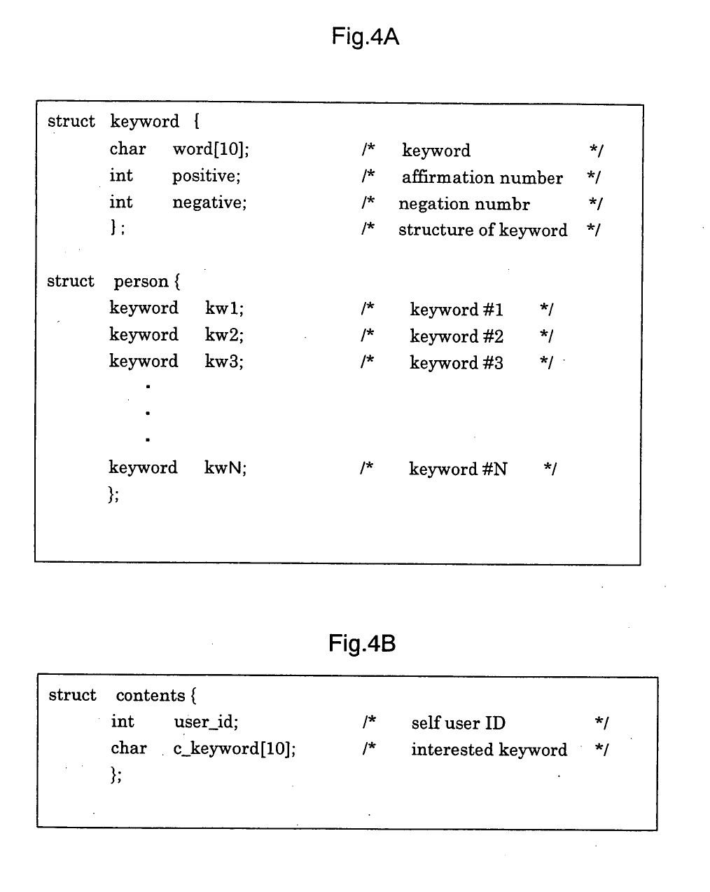

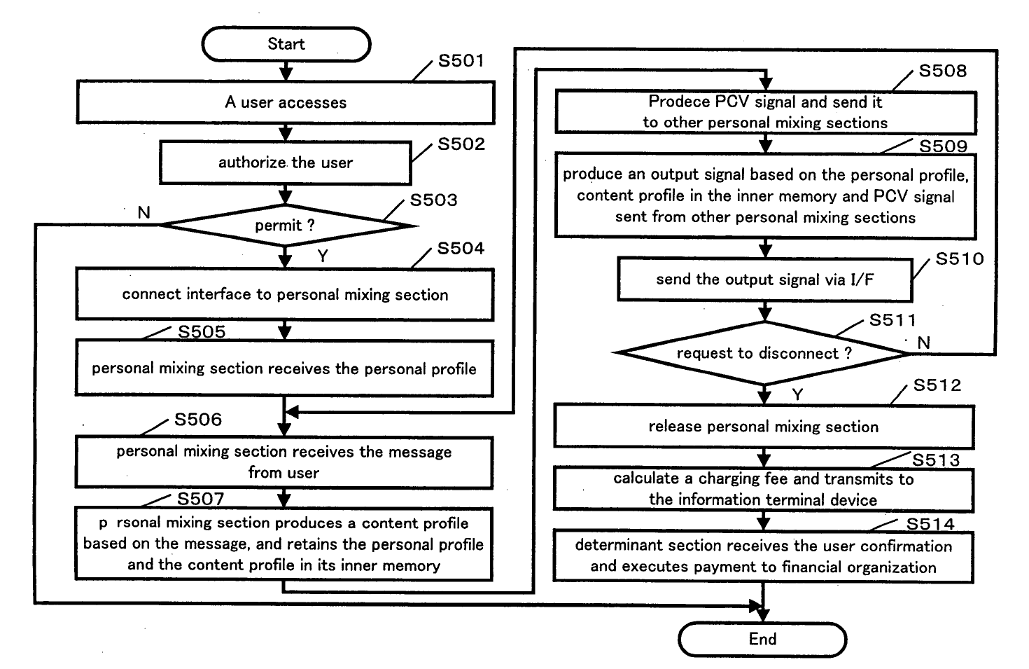

FIG. 4A shows a data structure of a personal profile. In FIG. 4A, the positive of the keyword takes a greater value as an importance of the interest targeted by the keyword becomes higher, i.e., an interest becomes deeper, and takes a smaller value as the importance becomes lower. The negative of the keyword takes a greater value as the importance of the interest targeted by the keyword becomes lower. Personal profile producing means 204 updates the number of affirmation and the number of negation about respective keywords with an input through input means 202. This procedure is detailed later.

Communication server 102 comprises the following elements:

interface section 116 for receiving an access from user's information terminal device 101;

connection exchange section 110 for changing a connection among respective functional sections within the system in response to an access request from a user;

mixing section 111 for synthesizing messages, formed of voices or sentences input to server 102, in response to an interest of individual users, and outputting the synthesized message;

user support section 112 for teaching how to use the system to a user who accesses server 102 for the first time;

user managing section 113 for deciding whether or not to permit a user to access;

fee calculating section 114 for calculating a fee of communication server 102; and

determinant section 115 for settlement of receipt and adjustment of the fee.

The structure discussed above can be formed by a calculating system or a computer.

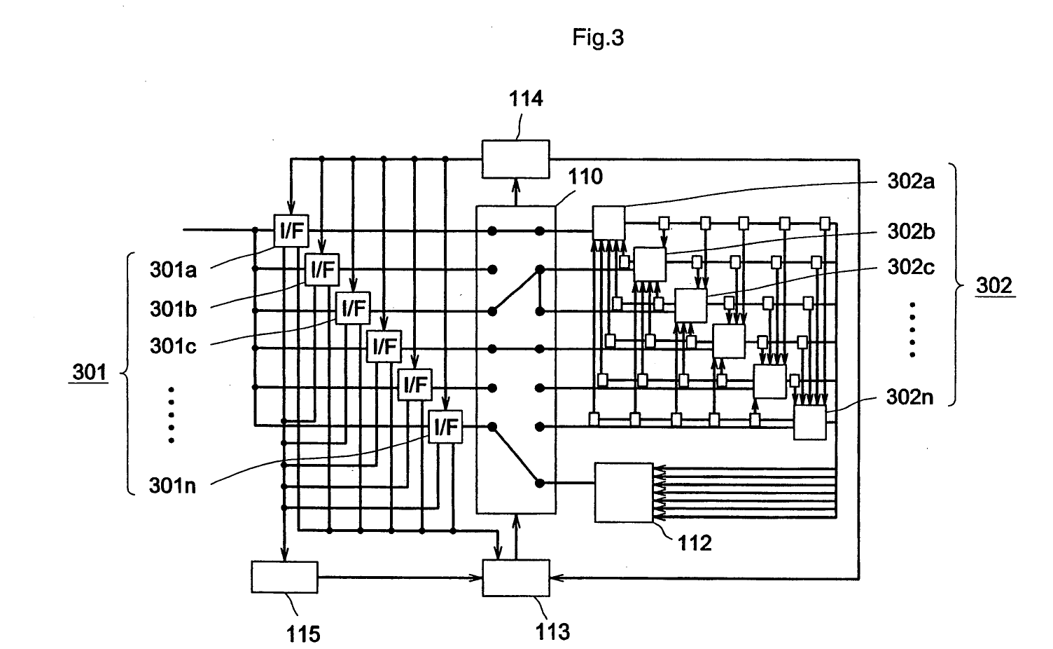

FIG. 3 is a wiring diagram of respective elements of communication server 102. Interface section 116 and mixing section 111 are an aggregate of interfaces 301 and an aggregate of personal mixing sections 302 respectively. Server 102 can receive accesses from the number of users corresponding to the number of interfaces 301 or personal mixing sections 302. Personal mixing sections 302 are coupled to each other in a matrix form, and one personal mixing section 302 can receive the outputs from all the other personal mixing sections 302. Respective outputs of all the personal mixing sections 302 can be coupled to any interface 301 by connection exchange section 110.

Interface 301 (in the FIGS., interface is referred to as I/F) is an interface device between a user and server 102 for receiving an access from the user who wants to have a conversation with another user sharing the same interest, or an interface device between server 102 and information communication network 104 to which server 102 outputs data.

Connection exchange section 110 includes a communication exchange function that couples interface 301 to personal mixing section 302. In the preferred embodiments, connection exchange section 110 controls a connection following an instruction from user managing section 113 and in response to a payment record of a user.

Each one of personal mixing section 302 (in this first embodiment, e.g., in FIG. 3, from the upper left to the lower right, the sections are denoted 302a, 302b, 302c . . . , 302n) is connected to connection exchange section 110, and on the other hand, e.g., one personal mixing section 302a can be coupled to all the other personal mixing sections (302b, 302c . . . , 302n). Personal mixing section 302a produces a content profile using a voice signal transmitted from interface 301a. A preferable content-profile is formed of a character-string (keyword) extracted from voice signals received in a given time. This keyword is searched from the same keyword-dictionary used for the personal profiles, so that it is preferable to install voice-recognition means in personal mixing section 302.

FIG. 4B shows a data structure of the content profile, where user's ID voiced is set at “user_id”, and a keyword extracted from the voice signal is set at “c_keyword[10]”. Personal mixing section 302 calculates a depth of similarity to a personal profile of another user sent from another personal mixing section 302 by using the content profile and the personal profile sent from interface 301. Personal mixing section 302 then mixes voice signals of the other user depending on the calculation.

User support section 112 teaches a user, who accesses server 102 for the first time, how to use the system. User managing section 113 determines whether or not to permit a user to access. In the preferred embodiments, user managing section 113 records and manages user's payment record and access record.

Fee calculating section 114 calculates an access time of a user based on a record stored in user managing section 113, and calculates a fee according to a given formula. Determinant section 115 charges the fee to financial organization 103 based on a payment execution command from a user. The foregoing elements constitute communication server 102.

Financial organization 103 is, e.g., a bank that makes settlement of the fee for communication services used by the users, and network 104 is, e.g., an information communication network using cable or radio. In the following description, a fee is charged depending on an access time used by a user; however, the fee can be charged in response to an information amount obtained by a user. Both of those charging systems are reasonable.

An operation of the communication support system discussed above is demonstrated hereinafter with reference to FIG. 5.

First, a user who wants to talk to a person sharing the same interest accesses interface 301 from information terminal device 101 via information communication network 104 (step S501.)

Interface 301 detects an access from the user and requests user managing section 113 to authorize the user (step S502.)

User managing section 113 determines whether or not to permit this access (step S503), and when the access is not permitted, the procedure is ended.

User managing section 113 records the time when the access is permitted, and sets connection exchange section 110 to connect interface 301 to personal mixing section 302 vacant as of this moment (step S504.)

In the case of the first time access of a user, the access is connected to user support section 112 so that necessary information can be provided to the user via information communication network 104. In the preferred embodiments, the user is asked about his or her interests through automatic voice response means. When the connection is established, a voice message of “connection is established” is preferably sent to information terminal device 101.

Next, when the access is permitted, information terminal device 101 transmits the personal profile including user's interest to personal mixing section 302 via interface 301 (step S505.)

Then the user inputs a topic he or she wants to discuss at present to microphone 201 of terminal device 101 with voice. Device 101 transmits this voice signal to personal mixing section 302 (step S506.) In the preferred embodiments, the personal profile retained in device 101 is automatically sent at the moment when a connection between device 101 and personal mixing section 302 is established. It is preferable to encourage the user to input a topic he or she wants to talk at present by assisting the user with a voice signal such as “what kind of party do you want to join?” sent from personal mixing section 302 and supplied to speaker 203.

Next, personal mixing section 302, which has received the personal profile and the voice signal, produces a content profile based on the voice signal, and retains the personal profile and the content profile in its inner memory (step S507.)

Personal mixing section 302 also transmits the personal profile, content profile and voice signal (the transmitted information including these three contents is referred to as PCV signal) to other personal mixing sections 302 (step S508.)

Then personal mixing section 302 calculates a depth of similarity between the personal profile and content profile stored in the inner memory and another personal profile and content profile sent from another personal mixing section 302 by using a given formula. Mixing section 302 then finds a weight related to the depth of similarity, and weights another voice signal transmitted from foregoing another personal mixing section 302, thereby synthesizing a plurality of messages for producing an output signal (step S509.)

The calculation of similarity depth and the synthesizing of messages by weighting are described hereinafter more specifically.

For instance, when personal mixing section 302j receives PCV(i) of PCV signal from personal mixing section 302i (i is not equal to j), section 302j calculates the depth of similarity between personal profile P(i), content profile C(i) in PCV(i) and personal profile P(j), content profile C(j) following the formula (1) shown below.

The preferred embodiments, using an information filtering function disclosed in Japanese Patent Unexamined Publication No. H09-288683 previously discussed, uses a keyword-dictionary, to be utilized by personal profiles, for converting a keyword into a vector. The personal profile is thus expressed in two matrixes, namely, affirmative matrix signal MY and negative matrix signal MN. The affirmative matrix signal expresses an affirmative depth about each one of keywords in an auto-correlation function, and the negative matrix signal expresses a negative depth about each one of keywords in an auto correlation function. The content profile is expressed in a first order vector “v” in which “1” is assigned to a keyword extracted from a voice and “0” is assigned to a keyword, not existed in the voice, of the personal profile.

A depth of similarity S (I, J) between two users (I and J) is calculated according to the following formula:

$$S ( I , J ) = {\sum }_{a} {\sum }_{x} D ( a , x ) {\sum }_{b} MY ( J ) [ a ] [ b ] v ( J ) [ b ] {\sum }_{y} MY ( I ) [ x ] [ y ] v ( I ) [ y ] - {\sum }_{a} {\sum }_{x} D ( a , x ) {\sum }_{b} MN ( J ) [ a ] [ b ] v ( J ) [ b ] {\sum }_{y} MN ( I ) [ x ] [ y ] v ( I ) [ y ] \qquad ( 1 )$$

where D(a, x) is a matrix which becomes “1” when the keyword at “a”th of keyword dictionary of user J's personal profile is equal to the keyword at “x”th of keyword dictionary of user I's personal profile, and D(a, x) becomes “0” in other cases. S(I, J) takes a great positive value when the two users (I and J) share the same interest [MY(I)−MY(J), and MN(I)−MN(J)], and talk about the same topic [v(I)−v(J)]. If the two users have totally different interests from each other, S(I, J)≈0, and when the two users have interests opposite to each other, S(I, J) takes a great negative value.

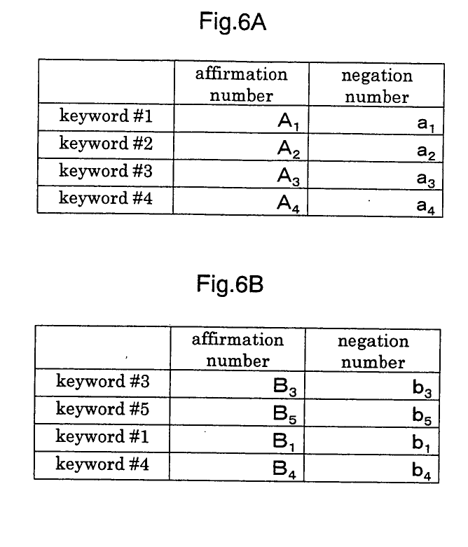

The foregoing calculation of the similarity depth is described more specifically with an embodiment shown in FIG. 6. FIG. 6A shows a depth of interest about each one of keywords set in the personal profile of user I, and greater number of affirmations indicates a deeper interest, and greater number of negations indicates a lighter interest.

$$( \begin{matrix}A 1 & 0 & 0 & 0 \\ 0 & A 2 & 0 & 0 \\ 0 & 0 & A 3 & 0 \\ 0 & 0 & 0 & A 4\end{matrix} ) ( \begin{matrix}1 \\ 0 \\ 1 \\ 0\end{matrix} ) = ( \begin{matrix}A 1 \\ 0 \\ A 3 \\ 0\end{matrix} ) \qquad ( 2 )$$

The above formula (2) indicates a matrix determinant calculating an affirmative depth of present interest based on the personal profile and the content profile of user I. The first term of the left side shows a matrix of auto-correlation function MY of the personal profile, and the second term shows a first order matrix of the content profile. The right side shows the result, which indicates only keyword 1 is valid among other keywords in which user I is interested.

FIG. 6B shows a depth of interest assigned to each one of keywords and indicated by a personal profile of user J. In the same manner as user J, the present interest depth of user J is calculated by formula (3).

$$( \begin{matrix}B 3 & 0 & 0 & 0 \\ 0 & B 5 & 0 & 0 \\ 0 & 0 & B 1 & 0 \\ 0 & 0 & 0 & B 4\end{matrix} ) ( \begin{matrix}1 \\ 0 \\ 0 \\ 0\end{matrix} ) = ( \begin{matrix}B 3 \\ 0 \\ 0 \\ 0\end{matrix} ) \qquad ( 3 )$$

However, as FIGS. 6A and 6B clearly show, an arranged sequence of keywords is different depending on a user, and the difference is corrected to re-arrange the keywords in the same sequence as that of user I, so that formula (4) is obtained.

$$( \begin{matrix}B 3 \\ 0 \\ 0 \\ 0\end{matrix} ) ( \begin{matrix}0 & 0 & 1 & 0 \\ 0 & 0 & 0 & 0 \\ 1 & 0 & 0 & 0 \\ 0 & 0 & 0 & 1\end{matrix} ) = ( \begin{matrix}0 \\ 0 \\ B 3 \\ 0\end{matrix} ) \qquad ( 4 )$$

The affirmative interest-depth is calculated above, and the negative interest-depth will be calculated by the following matrix determinant:

$$\begin{matrix}( \begin{matrix}a 1 & 0 & 0 & 0 \\ 0 & a 2 & 0 & 0 \\ 0 & 0 & a 3 & 0 \\ 0 & 0 & 0 & a 4\end{matrix} ) ( \begin{matrix}1 \\ 0 \\ 1 \\ 0\end{matrix} ) = ( \begin{matrix}a 1 \\ 0 \\ a 3 \\ 0\end{matrix} ) & ( 5 ) \\ ( \begin{matrix}b 3 & 0 & 0 & 0 \\ 0 & b 5 & 0 & 0 \\ 0 & 0 & b 1 & 0 \\ 0 & 0 & 0 & b 4\end{matrix} ) ( \begin{matrix}1 \\ 0 \\ 0 \\ 0\end{matrix} ) = ( \begin{matrix}b 3 \\ 0 \\ 0 \\ 0\end{matrix} ) & ( 6 ) \\ ( \begin{matrix}b 3 \\ 0 \\ 0 \\ 0\end{matrix} ) ( \begin{matrix}0 & 0 & 1 & 0 \\ 0 & 0 & 0 & 0 \\ 1 & 0 & 0 & 0 \\ 0 & 0 & 0 & 1\end{matrix} ) = ( \begin{matrix}0 \\ 0 \\ b 3 \\ 0\end{matrix} ) & ( 7 )\end{matrix}$$

Formula (5) indicates a negative present interest-depth of user I, formula (6) indicates a negative present interest-depth before the conversion of user J, and formula (7) indicates the same one but after the conversion. Those formulas are applied to formula (1), and formula (8) is obtained for calculating the similarity depth between user I and user J.

$$( \begin{matrix}0 \\ 0 \\ B 3 \\ 0\end{matrix} ) ( \begin{matrix}A 1 & 0 & A 3 & 0\end{matrix} ) - ( \begin{matrix}0 \\ 0 \\ b 3 \\ 0\end{matrix} ) ( \begin{matrix}0 & 0 & a 3 & 0\end{matrix} ) = A 3 * B 3 - a 3 * b 3 \qquad ( 8 )$$

As discussed above, an interest matching with a speech should be included in the personal profile for the calculation of the similarity depth between the speech of user I and the speech of user J, and the similarity depth can be changed with ease in response to a content of the speech.

The foregoing calculations are carried out for every user connected to server 102. The calculation of the similarity depth is not limited to the foregoing one, and another calculation method can be used as far as it satisfies the foregoing property.

Next, a weight is calculated for determining a method of synthesizing voice signals by using the foregoing similarity depth S(I, J). In the case of a positive similarity depth, an appropriate value is set in response to acoustic characteristics of the interface, and in the case of the similarity depth being equal to zero (0) or less than zero, zero (0) is set.

To be more specific, W (I, J)=γS(I, J), where γ is preferably a parameter for determining a voice volume. According to the weight, for instance, voices set to have different sound volume from each other are produced, thereby synthesizing a plurality of messages (step S509.)

One of the preferred embodiments expresses a synthesized voice signal MV (I) in formula (9).

$$MV ( I ) = {\sum }_{J} W ( I , J ) * V ( J ) \qquad ( 9 )$$

It is preferable to set the weight at zero (0) when the similarity depth calculated is not more than a given value, because this preparation can reduce noises.

A user ID is preferably assigned to one of the keywords included in a content profile. When a user wants to communicate with another user having a specific user ID, this preparation allows the similarity depth calculated by formula (1) to be deeper by setting a greater number of affirmations on importance degree of specific user's ID. On the contrary, when a greater number of negations is set on importance degree of specific user's ID, this preparation allows the similarity depth to be a negative value. The foregoing structure allows a user's ID to limit a conversation target.

Next, personal mixing section 302 transmits synthesized voice signal MV (I) and the content profile corresponding to this voice signal to information terminal device 101 (step S510.) Device 101 receives them and outputs the voice to the user through speaker 203.

The user is to hear a plurality of voices simultaneously, i.e., a voice at a large sound volume and a voice at a small sound volume. The voice close to the interest that the user spoke about sounds greater, and the voice not so close to the interest sounds weaker.

In the case that personal-file producing means 204 is equipped with the preferable information filtering function described in Japanese Patent Unexamined Publication No. H09-288683, when a user specifies a certain message (voice) and instructs inputting a speech of having an interest, e.g., “YES”, through input means 202, a plurality of keywords included in the content-profile received together with the message (voice) are registered in this user's personal profile. If those keywords have been registered in the user's personal profile, the counter indicating the degree of importance with the number of affirmations is counted up. On the contrary, if the user instructs inputting a speech of having no interest, e.g., “NO”, through input means 202, the number of negations, which indicates the importance degree of the plural keywords, is counted up.

If the user instructs inputting “delete keywords” through input means 202, a preferable structure deletes the keywords from the user's personal profile. This structure allows information terminal device 101 to add a keyword to a personal profile, or modify a value indicating an importance degree, by using input means 202 or a content-profile received.

Next, when a user disconnects the connection between information terminal device 101 and server 102 (step S511), device 101 sends a disconnect signal to interface 301, which then resets personal mixing section 302 engaged and releases it to another user (step S512.)

Interface 301 transmits a disconnect-time signal to fee calculating section 114, which then reads out the connection time stored in user managing section 113 for calculating an access time of the user with a predetermined formula. Fee calculating section 114 then informs user managing section 113 of a fee-charging signal and also transmits the signal to information terminal device 101. (step S513.)

The user confirms this fee-charging signal received by terminal device 101, and transmits the fee-charging signal together with an executing payment signal to determinant section 115 of server 102. When determinant section 115 receives those signals, it pays the fee from financial organization 103, and transmits a payment-over signal to user managing section 113 (step S514.)

The foregoing communication support system allows a user to hear a voice spoken by another user who talks about content at a deep similarity to the keyword spoken by the user. The other user's voice can be heard at the sound volume in response to the depth of similarity. Therefore, even if the user changes a topic, the user can always keep conversation with other users who share the present topic spoken by the user. For instance, if the topic talked in a conversation group which the user joins starts deviating from the interest of the user, the weight (I, J) between the user and another user starts approaching zero (0). As a result, the user is advantageously away from the conversation group in due course. If a conversation group of which topic is closer to the user's interest is generated, the sound volume of the speech spoken therein becomes louder based on the same mechanism, so that the user advantageously feels that the user becomes closer to the group.

Individual users can get those advantages, and as a whole, plural conversation groups are generated or terminated dynamically such as in an atmosphere of a buffet party. If a user speaks a sensible speech to two conversation groups, the two groups can be merged into one, or if a user speaks a senseless speech in a group, the group can be separated appropriately.

Further as described previously, when a user's ID is included in a content profile for specifying a counterpart, a user can speak to only this specified counterpart, or this preparation allows avoiding a conversation between two who are not in good congeniality with each other.

In the foregoing description, messages in voice are exchanged; however, a feature of the present invention is to change the transmission characteristics of information depending on how close the users have an interest to each other. In other words, easier transmissible characteristics for a closer interest is changed to harder transmissible characteristics for a weaker interest. Therefore, in the case of other modal such as text, a letter size instead of sound volume can be controlled with ease to obtain a similar advantage. For instance, a teleconferencing room using chat is the case. This teleconferencing room does not specify a topic but allows the participants to speak about any topic at any time. Thus when a user inputs a topic the user wants to talk about through an information terminal device in text, messages from other users are displayed on a screen of the information terminal device on a real time basis, and the messages are weighted by a size of letters similar to the synthesized voice signal output through the speaker. Even if the user changes a topic moment to moment, messages in text can be displayed similar to outputting voices.

Video signals can be sent together with voice signals and text data, so that a user can speak to another user by monitoring a video. A content profile can be produced in the information terminal device.

### Exemplary Embodiment 2

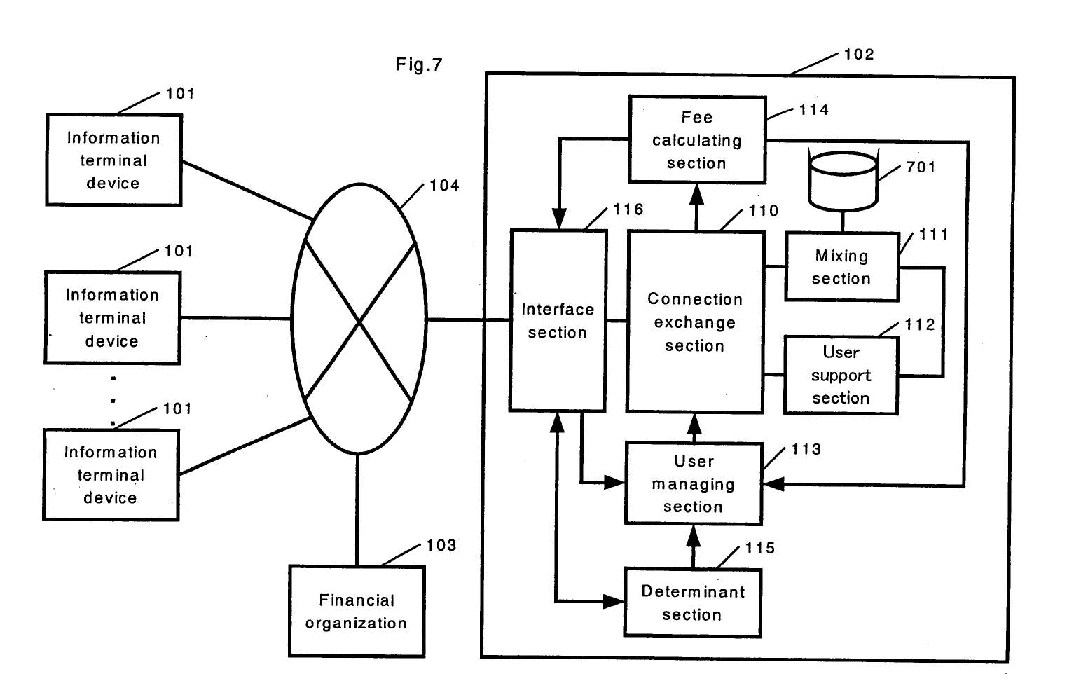

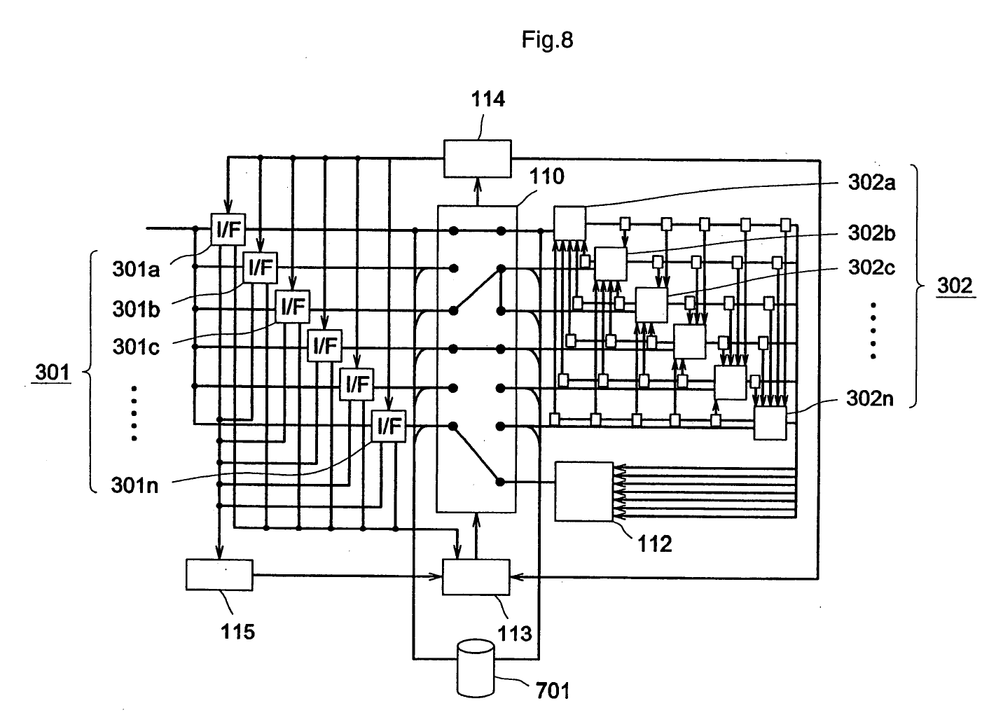

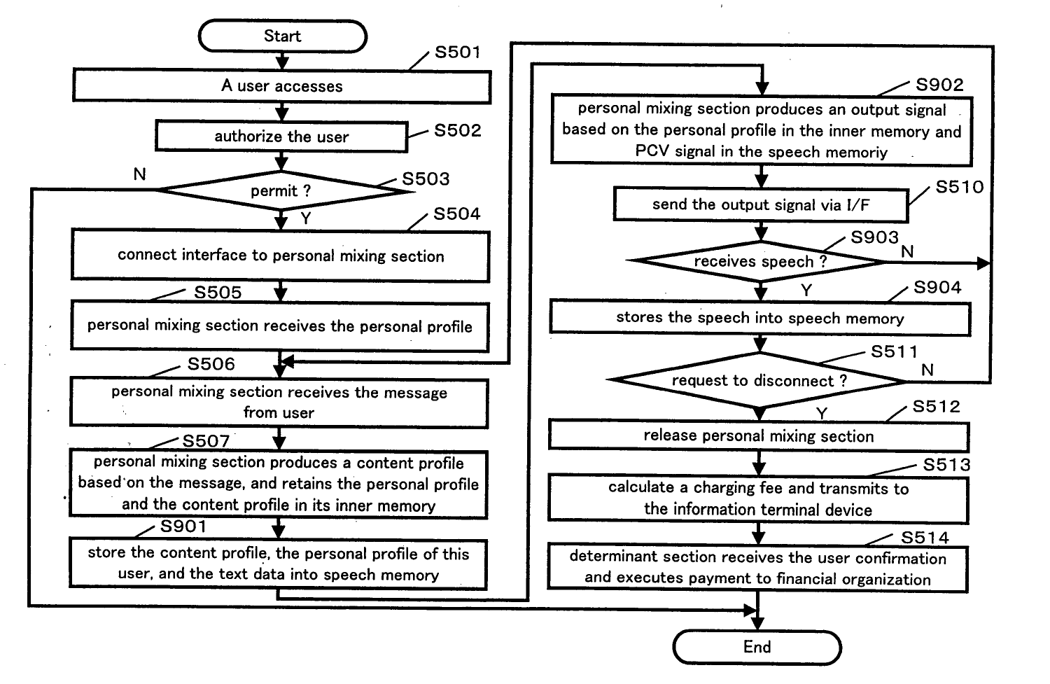

FIG. 7 is a block diagram illustrating a communication support system using text data in accordance with the second exemplary embodiment of the present invention. An electronic bulletin board is one of the examples of this embodiment. The communication support system using this bulletin board handles principally asynchronous communication, so that speech memory 701 for storing a user's speech and the electronic bulletin board for indicating a speech-history are included in the communication server besides the structure described in the first embodiment. As shown in FIG. 8, personal mixing section 302 reads out speeches spoken by users from speech-memory 701.

A minimum unit of a writing to the electronic bulletin board is a message, namely, a text written by an ordinary user. Plural messages in series are usually replied to a message. This series of messages is called a thread that is a practical unit of the electronic bulletin board.

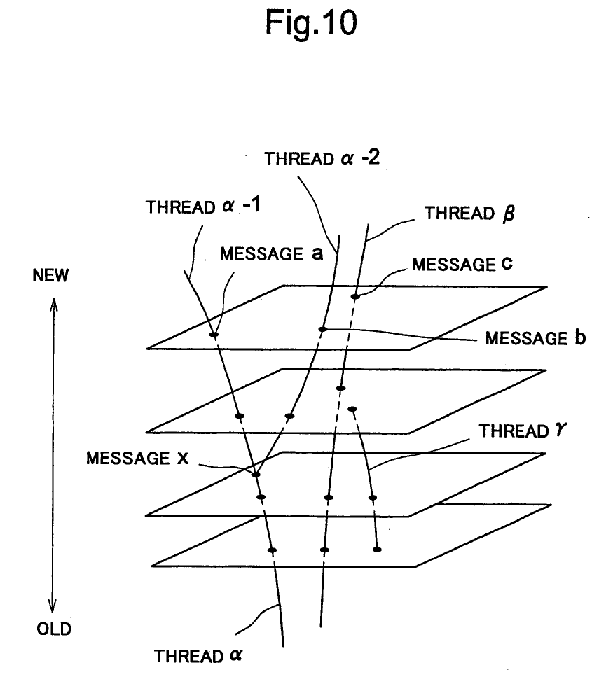

FIG. 10 shows a conceptual structure of the thread focusing on its content and an order of writings (it can be referred to as an amount of sequencing the messages in more general description.)

The amount of sequencing the messages can be defined by combining a writing sequence and times when the writings are done. In the case of focusing on the link between contents, the writing sequence is preferably to be used as the amount of sequencing the messages. In the case of focusing on full gear of a speech, the times are preferably used as the amount of sequencing messages. Each plane in FIG. 10 shows an extension of a content, and the writing sequence is shown in a plane. A thread is expressed with a line extending through the planes.

In FIG. 10, thread α, thread β which are split into two lines on the way, and thread γ which has a starting point and an endpoint, are shown. The split of thread is generated typically when a totally strange reply is addressed to a message “x”. In such a case, a message is newly attached to respective replies, so that a series of messages having different contents is produced. If a boring message is written, a short thread like thread γ having a starting point and an endpoint is produced. It is possible that the two threads merge into one.

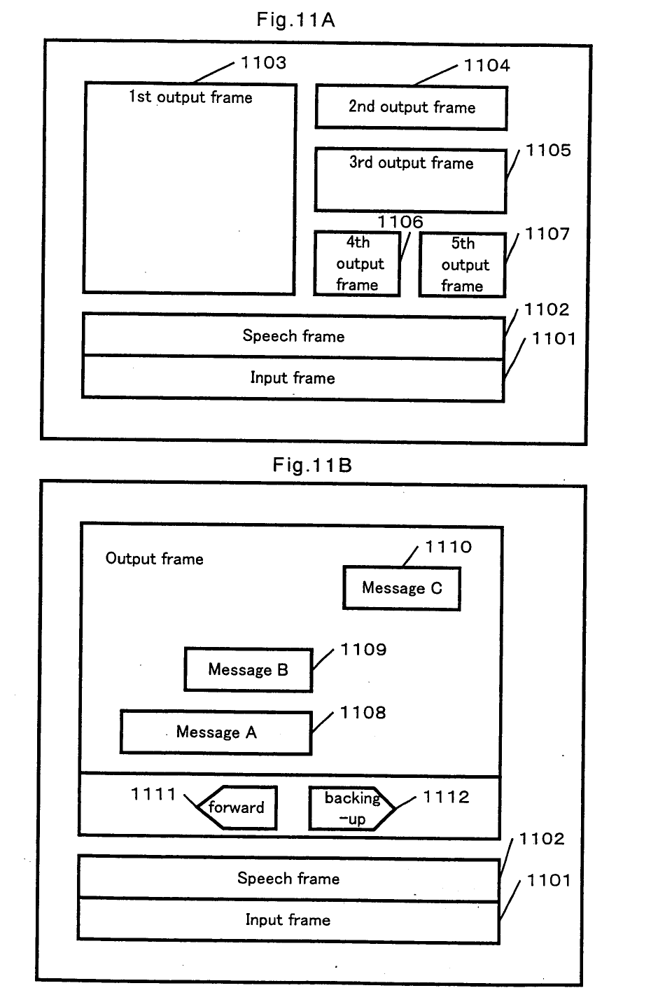

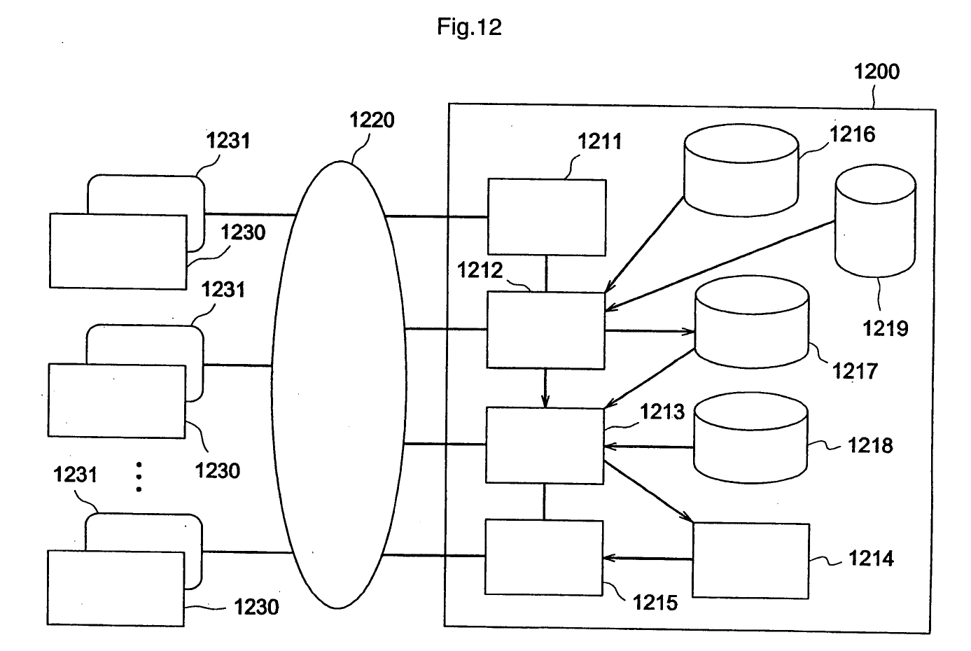

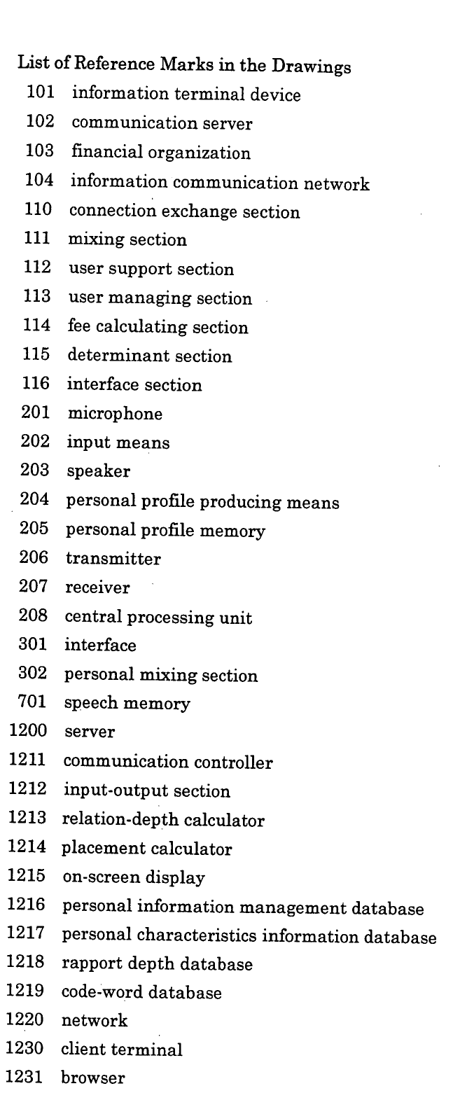

An operation of the second embodiment is demonstrated hereinafter with reference to FIG. 9 through FIG. 11. FIGS. 11A and 11B show interface screens of information terminal device 101. In FIG. 11A, input frame 1101 is an area where a user inputs a topic he or she wants to speak or hear at present. Output frames 1103 through 1107 are areas where messages of deepest similarity supplied from other users are shown. Speech frame 1102 is an area where the user puts his or her speech or reply to the messages shown in output frames 1103 through 1107.

FIG. 9 shows a flowchart of a procedure taken by the communication support system in accordance with the second embodiment. First, a user accesses connection exchange section 110. The steps from this access until the connection to personal mixing section 302 are the same as the those of the first embodiment (step S301 through step S304.)

Next, when the access is permitted, the user selects input frame 1101 and inputs a topic through input means 202, i.e., a keyboard. The input is displayed in input frame 1101. Information terminal device 101 transmits this input text data together with a personal profile produced in advance to personal mixing section 302 (steps S305 and S306.)

Then personal mixing section 302 produces a content profile based on the text data received in the same manner as the first embodiment, and stores the content profile in an inner memory (step S307.)

Personal mixing section 302 then stores the content profile, the personal profile of this user, and the text data into speech memory 701 (step S901.) Memory 701 adds those data to threads, and links those data to other users' data or produces a new thread.

Personal mixing section 302 takes out a set of content-profile and personal-profile one by one from speech memory 701, and calculates a depth of similarity following the calculation method described in the first embodiment by using the content-profile and the personal-profile stored in the inner memory. This calculation is carried out on every set of content-profile and personal-profile stored in speech memory 701, then a given number of groups are produced in the order of deeper similarity. Messages of the groups are extracted in the following manner.

First, the message of the deepest similarity is selected from the extracted messages, and if a message of second deepest similarity belongs to the same thread, select the message of later writing rather than earlier writing. If the message of second deepest similarity belongs to another thread, an order of writing the messages is focused, and the times of writing are disregarded. This procedure is repeated for the number of the selected messages. This method is preferable to a content-of-topic oriented case.

Next, personal mixing section 302 calculates weight “W” as discussed in the first embodiment, and synthesizes plural text-data weighted with a size of letters to be used for displaying messages (step S902.)

Personal mixing section 302 transmits a set of the text-data and the content-profile to information terminal device 101 (step S310.) Terminal device 101 receives those data and displays them in an output frame with a designated size of letter. To be more specific, the data is displayed in first output frame 1103 with the largest size of letter, and is displayed in second output frame 1104 with the second largest size of letter, and on ward, until in the fifth output frame 1107.

In this second embodiment, a size of letters is used as a weight; however, a color of letters, a typeface, and a density of letters can be used as a weight. In the case of density of letters, a message of the deepest similarity is expressed with the darkest density, and a lighter similarity is expressed with a lighter density. Those preparations allow a user to determine the depth of similarity through intuition.

As shown in FIG. 11B, plural messages 1108 through 1110 are preferably placed such that the distances between the messages are proportionate to the similarity of the contents. Further, when a user selects a message out of messages 1108 through 1110, and clicks forward button 1111 or backing-up button 1112, it is preferable that the procedure goes ahead or turns back along a thread. In such a case, a depth of similarity between the user and a user whose speech is selected along the thread is calculated based on the personal profile of this selected user and a content-profile found by the selected speech. If the depth of similarity results in a negative one, the speech is skipped. Therefore, if a speech does not match with the topic at clicking forward button 1111 or backing-up button 1112, the speech is not displayed.

If a user wants to speak or reply to a message displayed on an output frame, the user selects speech frame 1102 with a mouse-pointer and inputs a speech through the keyboard. The input is displayed in speech frame 1102 and also transmitted to server 102.

Personal mixing section 302 checks whether or not it receives the speech from information terminal device 101 (step S903), and if it does not receive the speech, return to step S306. If the speech is received, mixing section 302 stores the speech into speech memory 701 as a reply to the plural messages displayed in output frames 1103 through 1107 (step S904.)

Personal mixing section 302 then checks whether or not it receives a request from device 101 about disconnection (step S311.) The procedures onward (steps S312 through S314) stay unchanged as those in the first embodiment.

As discussed above, in this second embodiment, some other users, who have deeper similarity of an interest and a topic, among other users are grouped by server 102 based on keywords included in the messages supplied as well as a personal profile including the user's interest. Then past speeches of the group are extracted, and the speeches are displayed on information terminal device 101 with a size of letters changed in response to the similarity depth. This mechanism allows a user to determine the similarity of user's topic through intuition, and to read the speeches of other users having deeper similarity.

In a conventional electronic bulletin board, a thread is fixedly assigned to just quote a reply to which messages at a writing timing, and a thread has a clear tree-structure. Threads are classified and managed based on the tree-structures. However, according to the second embodiment, a relation between messages can be presented to users with not only a simple quotation but also contents of the messages, so that only a speech of deeper similarity of interest and topic can be displayed when the thread is forwarded or backed up. This mechanism saves a user an operation of repelling non-interesting speeches.

### Industrial Applicability

The present invention is useful for a communication support system to be used by plural users through an information communication network. The present invention allows each one of the users to change an object of his or her interest with ease, and to select on a real-time basis a counterpart who speaks to the user appropriately in response to the change.

1. A communication support method by which pluralities of users communicate appropriately with each other in response to respective interests of individual users through an information communication network, the method comprising the steps of:
finding a depth of similarity in response to an interest of an individual user by analyzing a personal profile including the user's interest and massage on a topic the user wants to talk about at present, both of the personal profile and the message being sent from each one of the users;
weighting the messages in response to the depths of similarity; and
synthesizing the weighted messages and transmitting the synthesized message.

2. A communication support method used by a plurality of users through an information communication network, the method comprising the steps of:
receiving a personal profile including a user's interest and a message on a topic the user wants to discuss at present, both of the personal profile and the message being sent from each one of the users;
analyzing the messages;
producing a depth of present interest of each one of the users respectively based on the analysis result and the personal profiles;
calculating a depth of similarity of interests between each one of the users based on the depth of interest;
synthesizing the messages of each one of the users based on the depth of similarity; and
transmitting the synthesized messages to the users.

3. The communication support method of claim 1, wherein each one of the personal profiles includes at least one of information about the user, information about the user's interest, and environmental information of the user's terminal.

4. The communication support method of claim 2, wherein each one of the personal profiles includes at least one of information about the user, information about the user's interest, and environmental information of the user's terminal.

5. The communication support method of claim 1 further comprising the step of converting the message with the depth of similarity as a weight.

6. The communication support method of claim 2 further comprising the step of converting the message with the depth of similarity as a weight.

7. The communication support method of claim 3 further comprising the step of converting the message with the depth of similarity as a weight.

8. The communication support method of claim 4 further comprising the step of converting the message with the depth of similarity as a weight.

9. The communication support method of claim 5 further comprising the steps of:
producing a content profile by extracting a keyword indicating a present interest by analyzing the message; and
transmitting the content profile together with the message.

10. The communication support method of claim 6 further comprising the steps of:
producing a content profile by extracting a keyword indicating a present interest by analyzing the message; and
transmitting the content profile together with the message.

11. A communication support method used by a plurality of users through an information communication network, the method comprising the steps of:
receiving a personal profile including a user's interest, and a message on a topic the user wants to discuss at present;
analyzing the message, extracting a keyword indicating a present interest, and producing a content profile;
preparing the message, the personal profile and the content profile into one set, and storing the set in a memory;
producing a depth of present interest based on the personal profile received and the content profile related to this personal profile;
calculating a depth of similarity by comparing the depth of the present interest with another depth of present interest based on the personal profile and the content profile read-out from the memory;
converting the message using the depth of similarity as a weight; and
transmitting the converted message.

12. The communication support system of claim 1, wherein the message is formed of at least one of voice and text.

13. The communication support system of claim 2, wherein the message is formed of at least one of voice and text.

14. The communication support system of claim 12 or claim 13, wherein the message is converted such that at least one of a sound volume, a sound quality, a size of letters, a color of letters and a typeface of the message is varied following the weight.

15. A communication server accessed by a plurality of users through an information communication network, the server comprising:
analyzing means for analyzing information (or a personal profile including an interest of one of the users', and a message on a topic the user wants to discuss at present) transmitted by the individual users;
finding means for finding a depth of similarity in response to the interest of individual users; and
transmitting means for synthesizing information (or the message) in response to the depth of similarity and transmitting the information (or the message).

16. A communication server accessed by a plurality of users through an information communication network, the server comprising:
receiving means for receiving a personal profile including an interest of one of the users, and a message on a topic the user wants to discuss at present, transmitted by the individual users;
analyzing means for analyzing the message;
producing means for producing a depth of present interest based on the analysis and the personal profile;
synthesizing means for synthesizing the messages based on the depth of the interest; and
transmitting means for transmitting the synthesized message.

17. The communication server of claim 16 further comprising converting means for converting the message with the depth of similarity as a weight.

18. The communication server of claim 17, wherein the analyzing means produces a content profile by extracting a keyword indicating a present interest, and the transmitting means transmits the content profile corresponding to the message.

19. A communication server used by a plurality of users through an information communication network, the server comprising:
receiving means for receiving a personal profile including an interest of one of the users and a message on a topic the user wants to discuss at present, both of the personal profile and the message being transmitted by the individual users;
producing means for producing a content profile by extracting a keyword, which indicates a present interest, from the message;
memory means for storing a set of the message, the personal profile and the content profile in a memory;
producing means for producing a depth of a present interest based on the personal profile received and the content-profile corresponding to the personal profile;
calculating means for calculating a depth of similarity by comparing the depth of the present interest with another depth of present interest produced from the personal profile and the content profile both read-out from the memory;
converting means for converting the message using the depth of similarity as a weight; and
transmitting means for transmitting the converted message.

20. The communication support system of claim 15, wherein the message is formed of at least one of voice and text.

21. The communication support system of claim 16, wherein the message is formed of at least one of voice and text.

22. The communication support system of claim 17, wherein the message is formed of at least one of voice and text.

23. The communication support system of any one of claim 20 through claim 22, wherein the message is converted such that at least one of a sound volume, a sound quality, a size of letters, a color of letters and a typeface of the message is varied following the weight.

24. A communication support system used by a plurality of users through an information communication network, the system comprising:
a communication server as defined in claim 15 through claim 23; and
an information terminal device including:
producing means for producing a personal profile having an interest of one of the users;
changing means for changing the personal profile;
inputting means for inputting a message on a topic the user wants to discuss at present;
transmitting means for transmitting the personal profile and the message to the communication server; and
receiving means for receiving the message supplied from the server.

25. The communication support system of claim 24, wherein the information terminal device further receives the content profile, and includes changing means for changing the personal profile by using the content profile.
